(19) United States
(12) Patent Application Publication
(10) Pub. No.: US 2011/0097633 A1
(43) Pub. Date: Apr. 28, 2011

(54) Fuel Cell System and Motor Vehicle with Such a Fuel Cell System

(75) Inventors: Philip Anumu, Koenigsbach-Stein (DE); Martin Gruber, Stuttgart (DE); Markus Grunenberg, Stuttgart (DE); Armin Muetschele, Weilheim (DE); Stefan Reiff, Kirchheim (DE); Christian Safran, Stuttgart (DE); Vera Schorbach, Naumburg (DE); Werner Schubert, Weinstadt (DE); Hans-Frieder Walz, Bad Ueberkingen (DE)

(73) Assignee: Daimler AG, Stuttgart (DE)

(21) Appl. No.: 12/935,223

(22) PCT Filed: Mar. 7, 2009
(86) PCT No.: PCT/EP2009/001647

§ 371 Date: Dec. 22, 2010

(30) Foreign Application Priority Data
Mar. 29, 2008 (DE) 102008016373.2

(51) Int. Cl. H01M 8/06

(52) U.S. Cl. 429/414

(57) ABSTRACT

In the operation of a fuel cell of a fuel cell system, water contained in the exhaust gas is stored in a water tank. The water tank has means for discharging the water in increments or portions. For example, the water can exit as droplets through the porous floor surface of the water tank, and be carried off by the driving wind while the vehicle is driving; or it can be collected at a wall of a water tank and fed into lines, returning it to the exhaust gas flow as droplets.

This application is a national stage of PCT International Application No. PCT/EP2009/001647, filed Mar. 7, 2009, which claims priority under 35 U.S.C. §119 to German Patent Application No. 10 2008 016 373.2, filed Mar. 29, 2008, the entire disclosure of which is herein expressly incorporated by reference.

### BACKGROUND AND SUMMARY OF THE INVENTION

The present invention relates to a fuel cell system comprising a fuel cell, in which a fuel is oxidized.

Fuel cells, which are currently the focus of much interest, generate exhaust gas containing water, which is discharged by an exhaust gas line. The water, however, should not be passed to the environment with the exhaust gas without further precautions. That is, ice formation can result, in particular on a road which is driven on by a motor vehicle that is operated with a fuel cell system. Such unhindered emission of liquid water is thus prohibited by law in some countries.

For this reason, the water contained in the exhaust gas, which may be in vapor form, is collected in a water tank. Mechanisms for separation of water are known from the state of the art.

German patent document DE 101 290 098 A1, for example, discloses that water can be separated out from an exhaust gas flow when the exhaust gas flow is guided over a line bending at a right angle. German patent document DE 101 200 18 A, on the other hand, describes a water separator for exhaust gas of a fuel cell system which has a water tank connected downstream (reservoir); and German patent document DE 10 2006 048 187 A1 also describes a water separator for exhaust gas of a fuel cell system.

International patent document WO 2005/112157 A2 describes a tank in which a separating element is provided, which serves that water in the tank is not discharged again, one has changed over to discharge the water deliberately from the tank:

A tank for water in an exhaust gas line is for example described in Published U.S. Patent Application No. 2006/0240299 A1, in which a heater is provided which serves for evaporating the water, wherein the water vapor then is returned into the exhaust gas flow.

Published U.S. Patent Application No. 2007/0007194 A1 describes to store the water in so-called buffer tanks in an intermediate manner and to discharge it again via outlets. The outlets are arranged in a definitive manner in the motor vehicle, such that the driving wind has as little influence as possible on the water discharge or carries the water along in a certain flow direction in a definitive manner.

The reason why, in the state of the art, water must be discharged again from the water tank, is that the water tank would have to be designed too large otherwise, if it is only emptied when filling the fuel for the fuel cell at a gas station. The collected water has a certain weight, this weight has to be transported with the vehicle. The evaporation of the water has however the disadvantage that a relative high amount of energy has to be provided hereby. If the water can flow out again via water outlets, too much water is possibly discharged. There are approaches to atomize the water from the exhaust gas by means of ultrasound without storing it intermediately in a water tank. This is also relatively energy-elaborate. There are further approaches to heat the water from the exhaust gas in a definitive manner without collecting it in a water tank. These solutions are often also very elaborate.

One object of the present invention is to provide a fuel cell system in which the exhaust gas is not directly discharged to the environment, but which overcomes the disadvantages of the fuel cell systems of the state of the art.

This and other object and advantages are achieved by the fuel cell system according to claim 1, which includes apparatus to discharge water from the water container in portions. As used in this sense, the term “in portions” implies that the water is discharged in amounts which are small with regard to the size of the water tank. On the other hand, the term also implies that the water amount that is discharged is not infinitely small, it is thus discharged in amounts which are several sizes above the size of a water molecule.

The present invention thus takes on an intermediate position between the method of Published U.S. Patent Application No. 2007/0007194 A1, in which the water flows directly from the water tanks (buffer tanks), and Published U.S. Patent Application No. 2006/0240299 A1, in which the water is discharged in molecular form (namely evaporated). The typical portion for water is usually a drop, so that a discharge of the water from the water tank in drops could be mentioned.

Because the water is first collected in the water tank, and then discharged in portions, the discharge of the water to the environment is independent of the load driven by the fuel cell, and in particular, of the formation of the water during the oxidation of the fuel in the fuel cell. As long as a relatively high amount of water is formed, it is possible that less water is again discharged from the water tank than is introduced. If the newly formed water amount is then reduced, the water amount in the water tank can again be reduced by again discharging more water than receiving it.

By the entirety of the water tank and means for the return in portions, a type of buffer step is introduced between the fuel cell and the environment. The water can by all means be discharged with the original exhaust gas. The means for returning the water in portions can thus comprise lines, which are provided in or at the water tank and which are arranged in such a manner that they guide water collected in the water tank to a location that is passed by the exhaust gas. The exhaust gas then virtually sweeps the water along, typically in droplets.

Additionally or alternatively to the return of the water collected in the water tank into the exhaust gas flow, it can also be provided that the water from the water tank is released more or less directly to the environment. The water tank can have a water-permeable wall for this. Moreover, bores can be provided in the water-permeable wall, so that the water then exits in rather larger drops, or the water-permeable wall can also be formed in a porous manner, so that the water then exits in rather smaller drops.

A motor vehicle with a fuel cell system according to the invention is also part of the invention.

When using the water tank with the water-permeable wall, it is preferably arranged in such a manner that water passing through it is carried along by driving wind during a drive. The water is carried along particularly fast by the driving wind, partially even swept along. The disadvantageous effects on the environment are additionally particularly low, as the driving wind can carry the water to arbitrary locations outside the motor vehicle. This is in particular advantageous compared to discharging the water from an exhaust, where the water impinges the road more or less at the same location relative to the motor vehicle.

The water-permeable wall can in particular form the floor of the water tank, so that the water is carried off through gravity, thus drips properly.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a fuel cell system according to a first embodiment of the invention; and

FIG. 2 is a schematic illustration of a section of a fuel cell system according to a second embodiment, namely in particular a water tank used hereby.

### DETAILED DESCRIPTION OF THE DRAWINGS

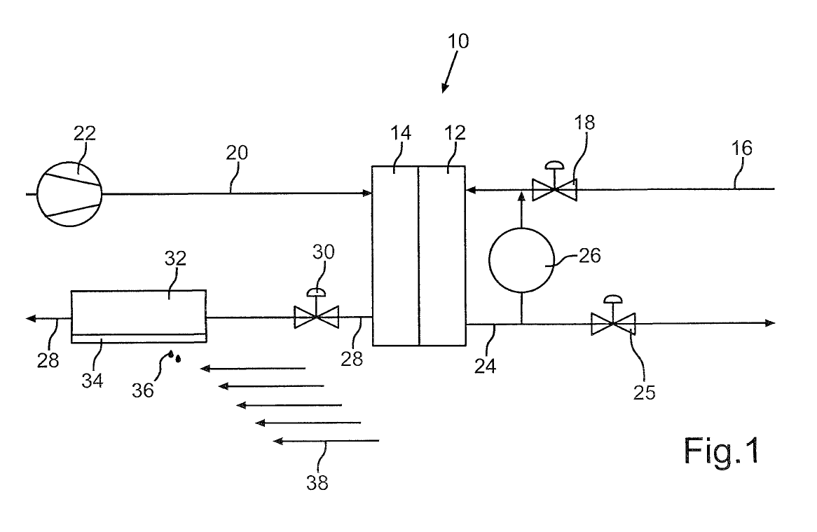

Referring to FIG. 1, a fuel cell 10 comprises at least one fuel cell (typically, several fuel cells) which includes an anode chamber 12 and a cathode chamber 14. A fuel is oxidized (combusted) in the fuel cells. The fuel is supplied to the anode chamber 12 via a line 16, wherein a valve 18 can control the fuel supply. The fuel is typically hydrogen. The oxidation means, typically air, is supplied to the cathode chamber 14, wherein the air is supplied via a line 20 and is precompressed by a compressor 22. The hydrogen which is not combusted exits again from the anode chamber 12, namely into a line 24, which leads to an outlet (not shown) via a valve 25. A return line 26 branches off from the line 24, so that fuel that is not combusted can be returned again. Exhaust gas that results during the combustion is discharged from the cathode chamber 14 via an exhaust gas line 28, wherein a valve 30 can influence the flow of the exhaust gas.

A water tank 32 is provided in the exhaust gas line, that is, presently in the exhaust gas line 28, in which tank water is separated from the exhaust gas in a manner known per se or in which discharged water is already collected in the line that has become cold. The water is typically the combustion product of the fuel when combusting hydrogen with oxygen from the air. The water tank 32 presently has a porous floor surface 34, through which water can exit in droplets. The water tank 32 is arranged in a motor vehicle, in which the fuel cell system 10 according to the invention is used, in such a manner that water drops 36 exiting from the porous floor surface 34 are carried along by a driving wind shown symbolically by the arrows 38.

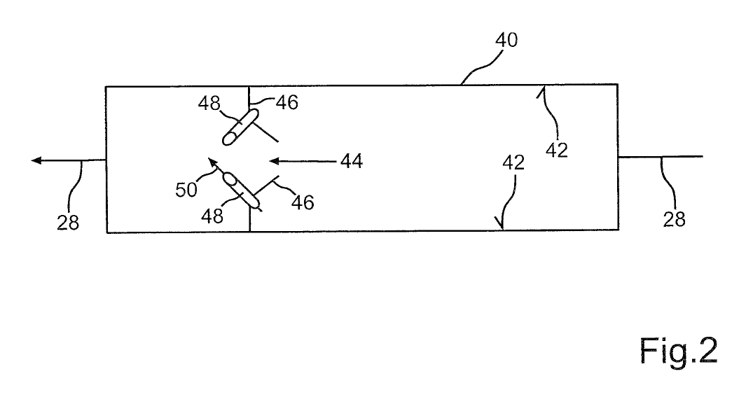

Instead of emitting the water via the porous floor surface 34 from the tank 32, the water can also by supplied again to the exhaust gas flow in droplets. The water tank 40 used in FIG. 2 can be used to replace the water tank 32 with the floor surface 34 in the fuel cell system of FIG. 1. The water tank 40, which is thus arranged in the exhaust gas line 28, is constructed in a manner known per se such that water from the exhaust gas flow condenses therein and precipitates at the walls 42 and that also water condensed out upstream in the line reaches the walls 42. Over time, a certain amount of water is collected. A constriction point 44 is now provided in the tank 40, so that the exhaust gas must flow through a constricted opening. It naturally flows through this constricted opening 44 faster than otherwise through the water tank 40. In the region of the walls 46 forming the constriction point 44 small lines are formed, in particular in the form of tubes 48 with nozzles at their exit end. The water is pressed from the walls 42 in the direction of the walls 46 by means of the exhaust gas flow. This water is then again fed exactly into the gaseous exhaust gas flow corresponding to the arrow 50, which flow passes through the opening 44.

The significance of the water tank 40 is that the water is again fed into the exhaust gas flow in droplets, thereby ensuring an even exit of the water from the fuel cell system altogether, in particular from the motor vehicle, in which the fuel cell system 10 is used. The water tank 40 thus has a buffer function. The water tank 32 also ensures that with a high load of the fuel cells (that is, with a temporally high combustion of fuel), an excessive amount of water is not passed to the environment at one time.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A fuel cell system comprising:
at least one fuel cell, which discharges an exhaust gas containing water during operation, through an exhaust gas line;
a water tank arranged to collect water in the exhaust gas line;
means for discharging the water in portions from the water tank;
a constriction point formed in the tank by walls, in which lines are formed, in such a manner that the exhaust gas flow flows faster through the constriction point and receives water passed from the lines in droplets.

11. A motor vehicle with a fuel cell system according to claim 10.

12. A method for operating a fuel cell system, in which exhaust gas entraining water is generated, said method comprising:
separating the water out from the exhaust gas;
collecting the water in a water tank; and
discharging the water from the water tank in portions.
